(19) United States
(12) Patent Application Publication
(10) Pub. No.: US 2007/0154230 A1
(43) Pub. Date: Jul. 5, 2007

(54) Method and apparatus for controlling fixing temperature of image forming device

(75) Inventor: Min-goo Choi, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/635,617

(22) Filed: Dec. 8, 2006

(30) Foreign Application Priority Data
Jan. 4, 2006 (KR) 10-2006-0000882

(51) Int. Cl. G03G 15/20

(52) U.S. Cl. 399/69

(57) ABSTRACT

A method and apparatus are provided for controlling a fixing temperature of an image forming device. The method includes measuring a temperature of a heat roller and a temperature of a pressure roller, which are included in a fixing unit, calculating a temperature difference between the temperature of the heat roller and the temperature of the pressure roller and if the calculated temperature difference is less than or equal to a predetermined value, beginning a printing job, and if the calculated temperature difference exceeds the predetermined value, the heat roller is continuously heated. Accordingly, when a print command is received after the image forming device is turned on or while in the power saving mode, a temperature of a heat roller and a temperature of a pressure roller are measured, and if a temperature difference between the temperature of the heat roller and the temperature of the pressure roller is less than or equal to a predetermined value, a printing job starts. Thus, by beginning a printing job when a fixing unit including the heat roller and the pressure roller reaches a fixing temperature, degradation of the fixing quality at the printing job starting time can be prevented.

### CROSS-REFERENCE TO RELATED PATENT APPLICATION

This application claims the benefit under 35 U.S.C. §119(a) of Korean Patent Application No. 10-2006-0000882, filed Jan. 4, 2006, in the Korean Intellectual Property Office, the entire disclosure of which is incorporated herein by reference.

### FIELD OF THE INVENTION

The present invention relates to an image forming device. More particularly, the present invention relates to a method and apparatus for controlling a fixing temperature of an image forming device.

### DESCRIPTION OF THE RELATED ART

A fixing unit is a device for fixing an image onto a printing medium by pressing and heating the printing medium on which the image is formed at a predetermined temperature in an image forming device. The fixing unit includes a pressure roller and a heat roller. The pressure roller is installed to contact the heat roller and rotate, and fixes an image formed on a printing medium by pressing. The heat roller fixes the image formed on the printing medium by heating. The heat roller includes a heating element, and a thermistor is attached to the surface of the heat roller and measures a surface temperature of the heat roller.

When a print command is received, the heat roller is heated by applying power to the heating element of the heat roller. The thermistor attached to the surface of the heat roller measures the surface temperature of the heat roller and provides the measured surface temperature to a fixing controller. The fixing controller determines whether the provided surface temperature has reached a temperature required for fixing (i.e., a fixing temperature), and if it is determined that the provided surface temperature has reached the fixing temperature, a printing medium is fed, and a printing job is started.

Thus, an important factor for determining a printing job starting time is the fixing temperature, and it is very important for fixing quality to determine whether a temperature of the fixing unit reaches the fixing temperature. In general, the fixing temperature is determined as a temperature of the heat roller, which is a temperature measured by the thermistor attached to the surface of the heat roller.

After a printing job starts, the heat of the heat roller and the heat of the pressure roller reach a heat-balance state, and thus, since the temperature of the pressure roller becomes substantially the same as the temperature of the heat roller, it is accepted that the temperature of the fixing unit is substantially the same as the temperature of the heat roller.

However, before a printing job starts right after the image forming device is turned on or after a power saving mode of the image forming device is released, the temperature of the fixing unit is lower than the temperature of the heat roller since the temperature of the pressure roller is lower than the temperature of the heat roller. Thus, in this case, even if the printing job starts since the temperature of the heat roller reaches a predetermined temperature, fixing quality at the printing job starting time is degraded since the temperature of the fixing unit is lower than the predetermined temperature.

Accordingly, a need exists for an improved system and method for controlling a fixing temperature of an image forming device.

### SUMMARY OF THE INVENTION

Embodiments of the present invention are provided to substantially solve the above and other problems, and provide a method and apparatus for controlling a fixing temperature of an image forming device and improving fixing quality at a printing job starting time by beginning a printing job when a fixing unit comprising a heat roller and a pressure roller, reaches a fixing temperature.

According to an aspect of embodiments of the present invention, a method of controlling a fixing temperature of an image forming device is provided, the method comprising measuring a temperature of a heat roller and a temperature of a pressure roller, which are included in a fixing unit, calculating a temperature difference between the temperature of the heat roller and the temperature of the pressure roller and if the calculated temperature difference is less than or equal to a predetermined value, beginning a printing job, wherein if the calculated temperature difference exceeds the predetermined value, the heat roller is continuously heated.

According to another aspect of embodiments of the present invention, an apparatus for controlling a fixing temperature of an image forming device is provided, the apparatus comprising a first thermistor for measuring a temperature of a heat roller, a second thermistor for measuring a temperature of a pressure roller, and a controller for calculating a temperature difference between the temperature of the heat roller and the temperature of the pressure roller and generating a control signal for beginning a printing job if the calculated temperature difference is less than or equal to a predetermined value and for continuously heating the heat roller if the calculated temperature difference exceeds the predetermined value.

The apparatus may further comprise a display unit for displaying a message that the heat roller is being heated while the heat roller is continuously heated.

### BRIEF DESCRIPTION OF THE DRAWINGS

The above and other features and advantages of embodiments of the present invention will become more apparent by describing in detail exemplary embodiments thereof with reference to the attached drawings, in which:

FIG. 1 is a block diagram of an exemplary apparatus for controlling a fixing temperature of an image forming device according to an embodiment of the present invention;

FIG. 2 illustrates a first exemplary thermistor, a second exemplary thermistor, an exemplary heat roller, and an exemplary pressure roller according to an embodiment of the present invention;

FIG. 3 is a flowchart illustrating an exemplary method of controlling a fixing temperature of an image forming device according to an embodiment of the present invention; and

FIG. 4 is a diagram showing exemplary variations of surface temperatures of the heat roller and the pressure roller over time according to an embodiment of the present invention.

Throughout the drawings, like reference numerals will be understood to refer to like parts, components and structures.

### DETAILED DESCRIPTION OF EXEMPLARY EMBODIMENTS

The present invention will now be described more fully with reference to the accompanying drawings, in which exemplary embodiments of the present invention are shown.

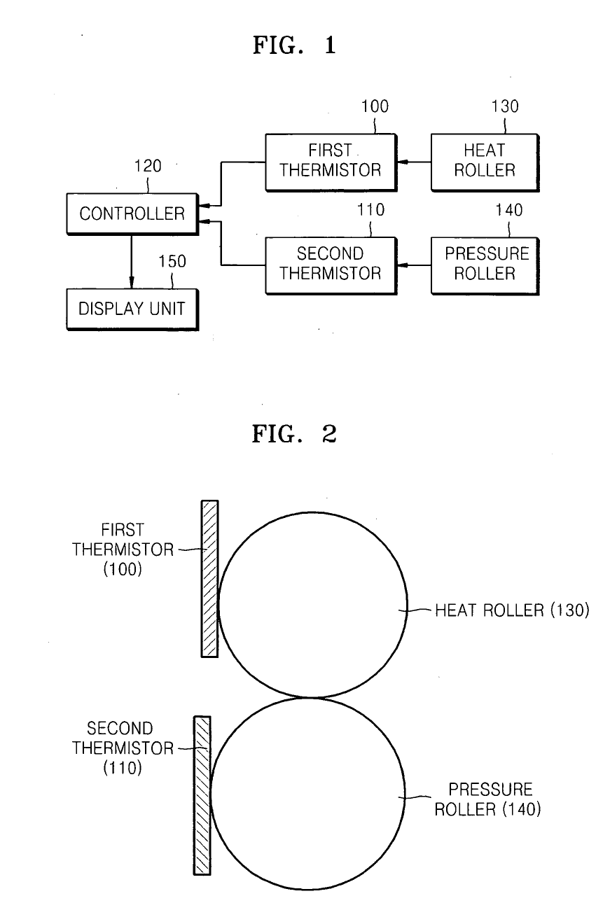

FIG. 1 is a block diagram of an exemplary apparatus for controlling a fixing temperature of an image forming device according to an embodiment of the present invention. FIG. 2 illustrates a first exemplary thermistor 100, a second exemplary thermistor 110, an exemplary heat roller 130, and an exemplary pressure roller 140 according to an embodiment of the present invention. Referring to FIGS. 1 and 2, the fixing temperature control apparatus comprises the first thermistor 100, the second thermistor 110, a controller 120, the heat roller 130, the pressure roller 140, and a display unit 150.

The first thermistor 100 is attached to the surface of the heat roller 130 as illustrated in FIG. 2, measures a surface temperature of the heat roller 130, and provides the measured temperature to the controller 120.

The second thermistor 110 is attached to the surface of the pressure roller 140 as illustrated in FIG. 2, measures a surface temperature of the pressure roller 140, and provides the measured temperature to the controller 120.

When a print command is received after the image forming device (not shown) is turned on or while in the power saving mode, the controller 120 determines whether a fixing unit including the heat roller 130 and the pressure roller 140 has reached the fixing temperature, and continuously heats the heat roller 130 until the fixing unit reaches the fixing temperature.

A method for the controller 120 to determine whether the fixing unit has reached the fixing temperature will now be described. When the surface temperature of the heat roller 130 and the surface temperature of the pressure roller 140 are input, the controller 120 calculates a temperature difference between the surface temperature of the heat roller 130 and the surface temperature of the pressure roller 140 and determines whether the calculated temperature difference is less than or equal to a predetermined value. The predetermined value indicates the minimum temperature difference between the heat roller 130 and the pressure roller 140, which satisfies fixing quality and varies according to image forming devices, and which is determined by factors such as rubber material and thickness of each of the heat roller 130 and the pressure roller 140.

If the calculated temperature difference is less than the predetermined value, the fixing unit has reached the fixing temperature and the controller 120 controls components of the image forming device to feed a printing medium and begin a printing job.

If the calculated temperature difference exceeds the predetermined value, the fixing unit has not reached the fixing temperature and the controller 120 continuously heats the heat roller 130 until the calculated temperature difference becomes less than or equal to the predetermined value. In this case, the controller 120 generates an exemplary message such as “waiting” or “heating.”

The display unit 150 informs a user that the heat roller 130 is being heated by displaying the message “waiting” or “heating” generated by the controller 120.

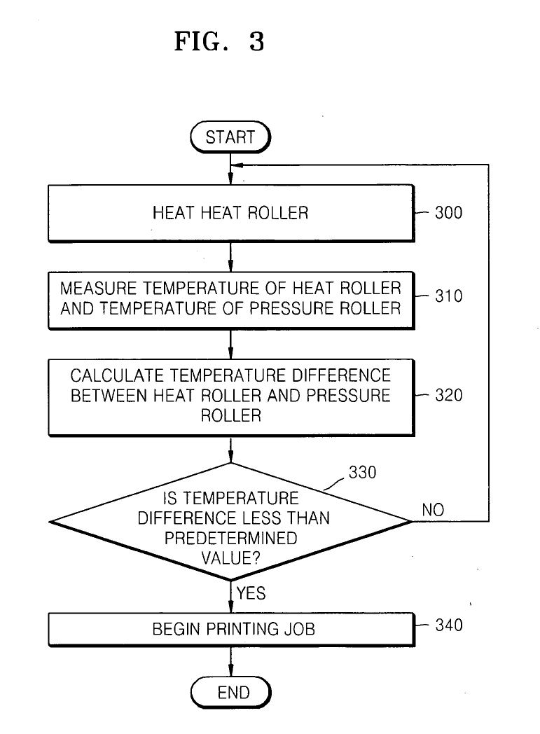

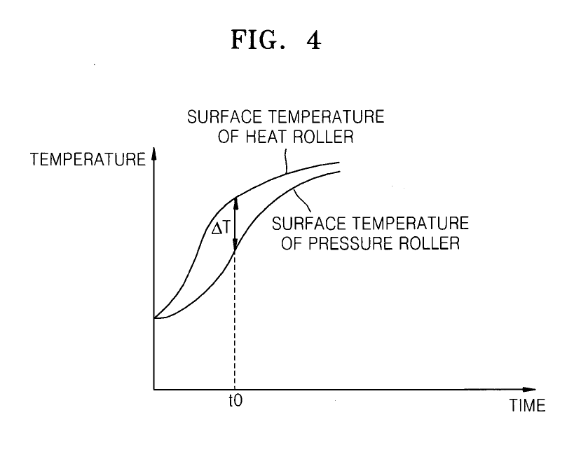

FIG. 3 is a flowchart illustrating an exemplary method of controlling a fixing temperature of an image forming device according to an embodiment of the present invention. FIG. 4 is a diagram showing exemplary variations of surface temperatures of the heat roller 130 and the pressure roller 140 over time according to an embodiment of the present invention.

An operation of the fixing temperature control apparatus according to an embodiment of the present invention will now be described in detail with reference to FIGS. 1, 3 and 4.

When a print command is received after the image forming device is turned on or while in the power saving mode, in operation 300, the controller 120 heats the heat roller 130 by applying power to a heating element (not shown) included in the heat roller 130 by generating a control signal for heating the heat roller 130. Here, the controller 120 can inform a user that the heat roller 130 is being heated by generating the message “waiting” or “heating”, and displaying the message on the display unit 150.

In operation 310, the first thermistor 100 measures the surface temperature of the heat roller 130 and provides the measured temperature to the controller 120, and the second thermistor 110 measures the surface temperature of the pressure roller 140 and provides the measured temperature to the controller 120.

In operation 320, the controller 120 calculates the temperature difference between the surface temperature of the heat roller 130 and the surface temperature of the pressure roller 140. FIG. 4 shows an illustration showing variations of surface temperatures of the heat roller 130 and the pressure roller 140 over time. As illustrated in FIG. 4, temperature increase ratios of the surface temperatures of the heat roller 130 and the pressure roller 140 vary from each other over time. Since the surface temperature of the pressure roller 140, which does not include a heating element, increases more slowly than the surface temperature of the heat roller 130, the surface temperature of the pressure roller 140 is lower by ΔT at t0. However, since the pressure roller 140 continuously receives heat from the heat roller 130, ΔT gradually decreases over time.

After calculating the surface temperature difference, in operation 330, the controller 120 determines whether the calculated surface temperature difference, i.e., ΔT, is less than or equal to a predetermined value. The predetermined value indicates the minimum temperature difference satisfying fixing quality and varies according to different image forming devices, and is determined by factors such as rubber materials and thicknesses of each of the heat roller 130 and the pressure roller 140.

If the calculated surface temperature difference exceeds the predetermined value, the fixing unit has not reached the fixing temperature and the process returns to operation 300, and the controller 120 continuously heats the heat roller 130 and displays a message that the heat roller 130 is being heated.

If the calculated surface temperature difference is less than or equal to the predetermined value, the fixing unit has reached the fixing temperature and in operation 340, a printing medium is fed and a printing job, such as charging, exposing, developing, transferring, fixing, and cleaning, is performed.

The exemplary embodiments of the present invention can be written as codes/instructions/programs and can be implemented in general-use digital computers that execute the codes/instructions/programs using a computer-readable recording medium. Examples of the computer-readable recording medium comprise magnetic storage media (e.g., ROM, floppy disks, hard disks, etc.), optical recording media (e.g., CD-ROMs, or DVDs), and storage media such as carrier waves (e.g., transmission through the Internet). The computer-readable recording medium can also be distributed over network coupled computer systems so that the computer-readable code is stored and executed in a distributed fashion. Also, functional programs, codes, and code segments for accomplishing embodiments of the present invention can be easily construed by programmers skilled in the art to which the present invention pertains.

As described above, a method and apparatus can be provided for controlling a fixing temperature of an image forming device according to embodiments of the present invention, such that when a print command is received after the image forming device is turned on or while in the power saving mode, a temperature of a heat roller and a temperature of a pressure roller are measured, and if a temperature difference between the temperature of the heat roller and the temperature of the pressure roller is less than a predetermined value, a printing job starts.

Thus, by beginning a printing job when a fixing unit including the heat roller and the pressure roller reaches a fixing temperature, degradation of the fixing quality at the printing job starting time can be prevented.

While the present invention has been particularly shown and described with reference to exemplary embodiments thereof, it will be understood by those skilled in the art that various changes in form and details may be made therein without departing from the spirit and scope of the present invention as defined by the appended claims. The exemplary embodiments should be considered in descriptive sense only and not for purposes of limitation. Therefore, the scope of the present invention is defined not by the detailed description of the invention but by the appended claims and their equivalents, and all differences within the scope will be construed as being included in the present invention.

What is claimed is:

1. A method of controlling a fixing temperature of an image forming device, the method comprising:
measuring a temperature of a heat roller and a temperature of a pressure roller, which are included in a fixing unit;
calculating a temperature difference between the temperature of the heat roller and the temperature of the pressure roller; and
if the calculated temperature difference is less than or equal to a predetermined value, beginning a printing job,
and if the calculated temperature difference exceeds the predetermined value, continuously heating the heat roller until the calculated temperature difference is less than or equal to a predetermined value.

2. An apparatus for controlling a fixing temperature of an image forming device, the apparatus comprising:
a first thermistor for measuring a temperature of a heat roller;
a second thermistor for measuring a temperature of a pressure roller; and
a controller for calculating a temperature difference between the temperature of the heat roller and the temperature of the pressure roller and generating a control signal for beginning a printing job if the calculated temperature difference is less than or equal to a predetermined value and for continuously heating the heat roller if the calculated temperature difference exceeds the predetermined value.

3. The apparatus of claim 2, further comprising a display unit for displaying a message that the heat roller is being heated while the heat roller is continuously heated.

4. A method of controlling a fixing temperature of an image forming device, the method comprising:
receiving a print command at an image forming device wherein the image forming device is recently turned on or in a power saving mode;
generating a control signal for heating a heat roller and generating and displaying a message denoting the heating of the heat roller;
receiving a signal of at least one of a first thermistor for measuring a surface temperature of the heat roller, and a second thermistor for measuring a surface temperature of a pressure roller;
calculating a temperature difference between the surface temperature of the heat roller and the surface temperature of the pressure roller and determining whether the calculated surface temperature difference is less than or equal to a predetermined value; and
if the calculated surface temperature difference exceeds the predetermined value, continuously heating the heat roller and displaying the message that the heat roller is being heated, and
if the calculated surface temperature difference is less than or equal to the predetermined value, performing a printing job.

5. A computer-readable recording medium having stored thereon instructions for controlling a fixing temperature of an image forming device, comprising:
a first set of instructions for controlling a first thermistor to measure a temperature of a heat roller and a second thermistor to measure a temperature of a pressure roller, which are included in a fixing unit;
a second set of instructions for calculating a temperature difference between the temperature of the heat roller and the temperature of the pressure roller; and
if the calculated temperature difference is less than or equal to a predetermined value, a third set of instructions for controlling an image forming device to begin a printing job,
and if the calculated temperature difference exceeds the predetermined value, a fourth set of instructions for controlling the fixing unit to continuously heat the heat roller until the calculated temperature difference is less than or equal to a predetermined value.

6. The computer-readable recording medium of claim 5, further comprising a set of instructions for delaying the printing job until the calculated temperature difference is less than or equal to a predetermined value.

7. The computer-readable recording medium of claim 6, further comprising a set of instructions for providing a message to a user during the period when the printing job is delayed.

8. The computer-readable recording medium of claim 5, further comprising a set of instructions for providing a message to a user during the period when the heating roller is being heated.

9. A computer-readable recording medium having stored thereon instructions for controlling a fixing temperature of an image forming device, comprising:
a first set of instructions for controlling a first thermistor for measuring a temperature of a heat roller;
a second set of instructions for controlling a second thermistor for measuring a temperature of a pressure roller; and
a third set of instructions for controlling a controller for calculating a temperature difference between the temperature of the heat roller and the temperature of the pressure roller and generating a control signal for beginning a printing job if the calculated temperature difference is less than or equal to a predetermined value and for continuously heating the heat roller if the calculated temperature difference exceeds the predetermined value.

10. The computer-readable recording medium of claim 9, further comprising a set of instructions for controlling a display unit for displaying a message that the heat roller is being heated while the heat roller is continuously heated.
